(19) United States
(12) Patent Application Publication
(10) Pub. No.: US 2003/0084099 A1
(43) Pub. Date: May 1, 2003

(54) Apparatus, method, and computer program product

(76) Inventor: Hiroshige Kamine, Fukuoka-shi (JP)

Correspondence Address: RATNERPRESTIA, P O BOX 980, VALLEY FORGE, PA, 19482-0980, US

(21) Appl. No.: 10/282,649

(22) Filed: Oct. 28, 2002

(30) Foreign Application Priority Data
Oct. 26, 2001 (JP) 2001-328838

(51) Int. Cl. G06F 15/16

(52) U.S. Cl. 709/203; 715/513

(57) ABSTRACT

An apparatus and method enhancing efficiency in a Web page-updating routine. Employing extended tags—other than the commonly used tags in an HTML-written file (hereinafter, HTML-file), the present invention allows the user to designate correction-expected items in the HTML-file with the extended tags. With a mobile terminal, the user calls up an extended tag-inserted HTML-file from a Web server on the Internet to the screen of the terminal. The terminal explicitly shows the items marked with the extended tags and prompts the user to enter correction data. That is, the mobile terminal not only serves as a Web browser, but also analyzes the extended tags and accepts data-entry. Each time correction is given, the correction data is transmitted to the Web server for updating the HTML-file. Allowing the terminal to have a correction-dedicated page further accelerates the updating routine.

### FIELD OF THE INVENTION

The present invention relates to Web page-updating technique with which a Web page publicized over the Internet can be easily updated by the user.

### BACKGROUND OF THE INVENTION

Nowadays, a process of creating/updating a Web page has been mainly performed through a personal computer (PC). For example, to update a Web page, 1) starting up a program for editing Web pages written by HyperText Markup Language (HTML) on the PC; 2) performing correction required in the pages by a person well skilled in using the program; and 3) transmitting the corrected Web page to a Web server. Here will be described a conventional procedure of updating the contents, through a PC, of a Web page publicized over the Internet.

FIG. 13 is a block diagram indicating the structure of a PC that serves as a Web page editor. Web page editor 130, as shown in the figure, includes:

a) central processing unit (CPU) 131 for manipulating data according to given instructions;

b) display 132 for displaying text and graphics;

c) data-entry section 133 that allows the user to input information or to designate an area to be processed in the correction;

d) storage section 135 for storing data and programs.

Storage section 135 further contains:

d-1) communicator 136 for transmitting/receiving files written by HTML (hereinafter referred to as HTML-files) via the Internet;

d-2) HTML-page manager 137 for managing a Web page to be corrected;

d-3) HTML analyzer 138 for analyzing an HTML-file according to HTML specifications;

d-4) layout section 139 for determining the coordinate data for each display element to be shown on a terminal;

d-5) page display 140 for displaying an HTML-file including text and graphics;

d-6) page browser 141 responsible for changing screen by means of, for example, scrolling; and

d-7) HTML-page editing program 142 for changing the contents of an HTML-file: this is an application completely different from a commonly used Web browser that enables the user to navigate the World Wide Web (WWW).

FIG. 14 is a flow chart illustrating the conventional steps of updating the contents of a Web page on the Internet through Web page editor 130 shown in FIG. 13. In S14, a user—in most cases, the author of a Web page—starts up a Web browser—this is a generic name for programs that enable users to browse Web pages written by HTML—installed in the PC. In S15, to read desired Web page into the PC, the user designates the Uniform Resource Locator (URL) for the Web page to be corrected. In the meantime, the browser analyzes the contents of the Web page with reference to HTML specifications in S16. In S17, according to the result analyzed in S16, the browser determines the location of display elements in the Web page so that each element is placed in a proper position on the screen. In S18, the browser displays the Web page according to the layout arranged in S17. Viewing the Web page invoked by the processes above, the user checks to make sure that the page has contents to be corrected. Then in S19, the user starts up another program: HTML-file editor—the application for editing files written by HTML—in order to read the Web page to be corrected. Operating the editor, the user changes text or graphics in the page in S20. On completion of correction for the page in S21, the user exits from the editor in S22.

However, there are inconveniencies in the conventional updating method described above. That is, the updating process needs the user well skilled in operating not only the Web browser but also the HTML-file editor. Besides, the user has to manipulate two or more applications: each time the contents of the page needs updating, the user starts up the editing program—other than the Web browser; and after performing corrections required, the user exits the program. As a result, the more frequent the Web page is rewritten, the more increase in time and effort of the person who is in charge of updating the page. This fact has posed low efficiency to the updating routine.

Recent years have seen an explosive growth of mobile terminals typified by mobile telephones. Under the circumstance, the users have obtained access to the Internet at anytime and anywhere. On the other hand, it is also true that much-needed information is not often available when a user visits a Web page on the Internet: sometimes, the information obtained has no longer been “fresh”. That is, the user is eager for on-target information through the access, whereas the contents of a Web page may become obsolete due to no updating for a while. The inconvenience may come from the updating process with low efficiency described above: the complicated updating routine can deprive “freshness” from information in a Web page.

Japanese Patent Application Non-Examined Publication No. 2002-74176 introduces a method of updating a Web page for a restaurant. According to the method, important information attracting customers can be easily updated through the tiny display of a mobile telephone even if the user has no space for setting a PC or skill and time for manipulating the PC. However, the description has nothing for practical use. Similarly, Japanese Patent Application Non-Examined Publication No. 2002-82871 introduces a method in which a user, even without expertise, can easily write a Web page and put it up on the Internet, or rewrite it. The description, too, has nothing for practical use therein.

Under the circumstance in which the use of the Internet has the ever-increasing of diversity, offering fresh information to the users has been crucial. The need of an improved method that allows information providers—i.e., authors of Web pages—to update their pages with ease and efficiency has been constantly increasing.

### SUMMARY OF THE INVENTION

The Web page-updating apparatus of the present invention connects to a Web server on the Internet to rewrite data in Web pages on the server. Employing extended tags—other than the commonly used tags in an HTML-written file (hereinafter referred to as HTML-file), the present invention allows the user to designate correction-expected items in the HTML-file with the extended tags. When receiving an HTML-file including extended tags in addition to commonly used tags, the apparatus displays an HTML-written source (in the description hereinafter, it is referred to as an HTML-page). In the HTML-page, display elements and tags (including the extended tags) are shown together in such a way that the display elements are enclosed by a pair of tags (including extended tags). When the user gives correction to display elements enclosed by extended tags, the apparatus transmits the correction to the server.

The apparatus of the present invention includes a) a display for displaying a Web page and b) a storage section for storing data and programs. The storage section further includes:

b-1) an extended-tag table for storing the extended tags that indicate the items to be corrected in an HTML-file of the Web page;

b-2) an extended-tag analyzer for analyzing the extended tags written in the file and extracting an item sandwiched between the extended tags;

b-3) a correction data-entry section for preparing a data-entry window on the display in which the user can input data with attribute that each extended tag shows; and

b-4) a page rewriter that rewrites the HTML-file on the server, when the user gives correction to an item indicated by the extended tags.

The Web page-updating method of the present invention includes the following steps:

a) receiving an HTML-file from a server on the Internet;

b) displaying the HTML-file as an HTML-page, in which display elements including items marked with extended tags are shown in a case that the HTML-file includes the extended tags;

c) transmitting correction data, which is given to an item marked with the extended tags, to the server; and

d) rewriting the contents of the HTML-file on the server according to the correction data.

The computer program product of the present invention includes computer program code to execute the Web page-updating process described above.

### BRIEF DESCRIPTION OF THE DRAWINGS

FIG. 1 is a block diagram of the Web page-updating apparatus in accordance with a first preferred embodiment of the present invention.

FIG. 2 is a flow chart illustrating the Web page-updating steps in accordance with the first preferred embodiment.

FIG. 3 is a diagram illustrating two display-modes of the apparatus in accordance with the first preferred embodiment.

FIG. 4 is a diagram illustrating the difference between the displays according to the two display-modes of the apparatus in accordance with the first preferred embodiment.

FIG. 5 is a diagram illustrating the updating process of the apparatus in accordance with the first preferred embodiment.

FIG. 6 is a diagram illustrating the extended tags used in the updating process in accordance with the first preferred embodiment.

FIG. 7 is another diagram illustrating the updating process of the apparatus in accordance with the first preferred embodiment.

FIG. 8 is another diagram illustrating the extended tags used in the updating process in accordance with the first preferred embodiment.

FIG. 9 is a diagram illustrating an updating process of the apparatus in accordance with a second preferred embodiment.

FIG. 10 is another diagram illustrating the updating process of the apparatus in accordance with the second preferred embodiment.

FIG. 11 is a diagram illustrating a rewriting process, via the Internet, of the apparatus in accordance with the second preferred embodiment.

FIG. 12 is a diagram illustrating the rewriting process of the apparatus in accordance with the second preferred embodiment.

FIG. 13 is a block diagram illustrating the structure of prior-art Web page-updating apparatus having an access to the Internet.

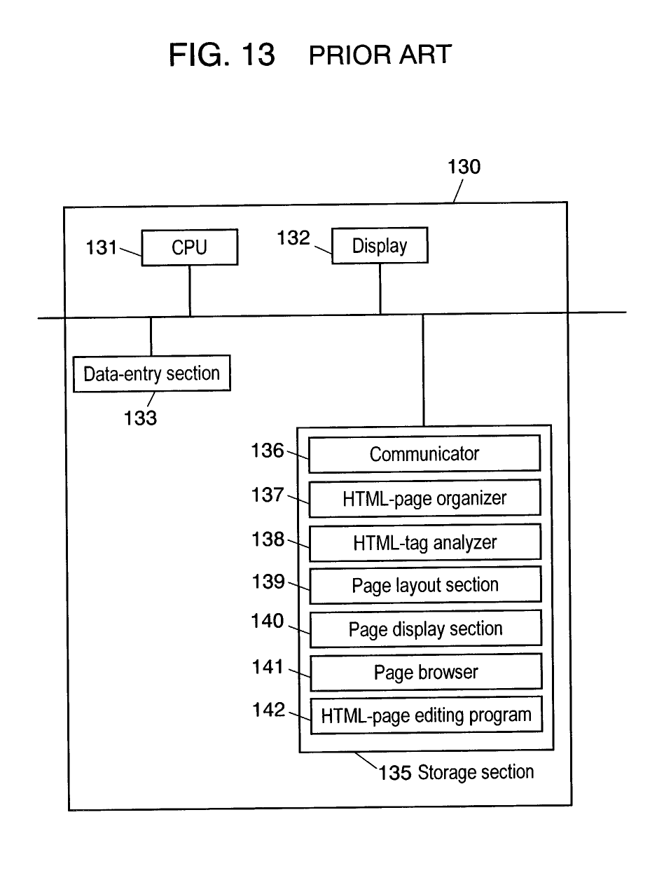

FIG. 14 is a flow chart illustrating for prior-art steps of updating Web pages having an access to the Internet.

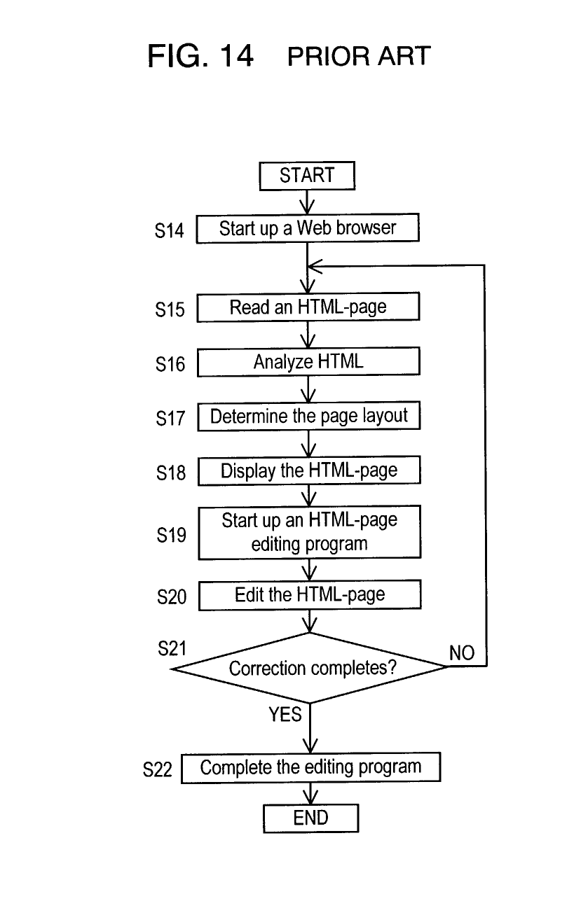

### DESCRIPTION OF THE PREFERRED EMBODIMENTS

The preferred embodiments of the present invention are described hereinafter with reference to the accompanying drawings. Like elements have same reference marks throughout the drawings, and the descriptions of those elements are omitted.

First Preferred Embodiment

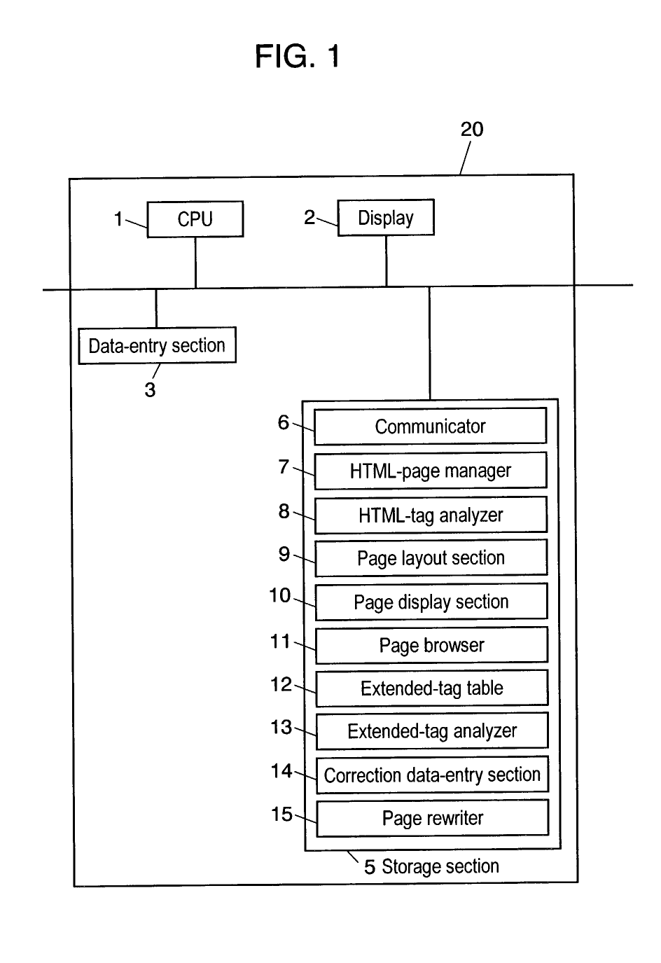

FIG. 1 is a block diagram illustrating the functional structure of Web page-updating apparatus 20 in accordance with the first preferred embodiment. Web page-updating apparatus 20 (hereinafter simply referred to as apparatus 20) is, to be more specific, a mobile terminal equipped with application programs for updating Web pages with the help of extended tags. Like a function of a Web browser, apparatus 20 has a function to show a Web page written in common HyperText Markup Language (HTML). Besides, apparatus 20 analyzes extended tags, accepts correction data-entry, and keeps track of Web pages to be corrected. Having access to Web pages on a Web server on the Internet to rewrite the Web page, apparatus 20 reads a file written by HTML (hereinafter referred to as an HTML-file) having the extended tags that indicate the item to be corrected. Locating the extended tags in the page, apparatus 20 offers the user easy correction.

In apparatus 20 shown in FIG. 1, central processing unit (CPU) 1 controls each section to execute a routine task according to a program stored in storage section 5. Display 2 displays data including text and graphics on the screen. Data-entry section 3 accepts data-entry or designation on an area for correction. Storage section 5 stores data and programs. Storage section 5 further contains sections below:

a) communicator 6 exchanges an HTML-file with the server via the Internet;

b) HTML-page organizer 7 keeps track of the pages to be corrected in apparatus 20;

c) HTML analyzer 8 analyzes an HTML-file according to HTML specifications;

d) page layout section 9 determines the coordinates of display elements to be displayed on the display of a terminal;

e) page display section 10 shows the HTML-file including text and graphics on the display of the terminal;

f) page browser 11 is responsible for changing the screen, by means of, for example, scrolling;

g) extended-tag table 12 contains extended tags with which the items and their attributes to be corrected are designated;

h) extended-tag analyzer 13 analyzes the extended tags described in the page;

i) correction data-entry section 14 prepares the entry window corresponding to each type of the extended tags; and

j) page rewriter 15 rewrites the HTML-file in response to the correction data-entry given to the item having the extended tags.

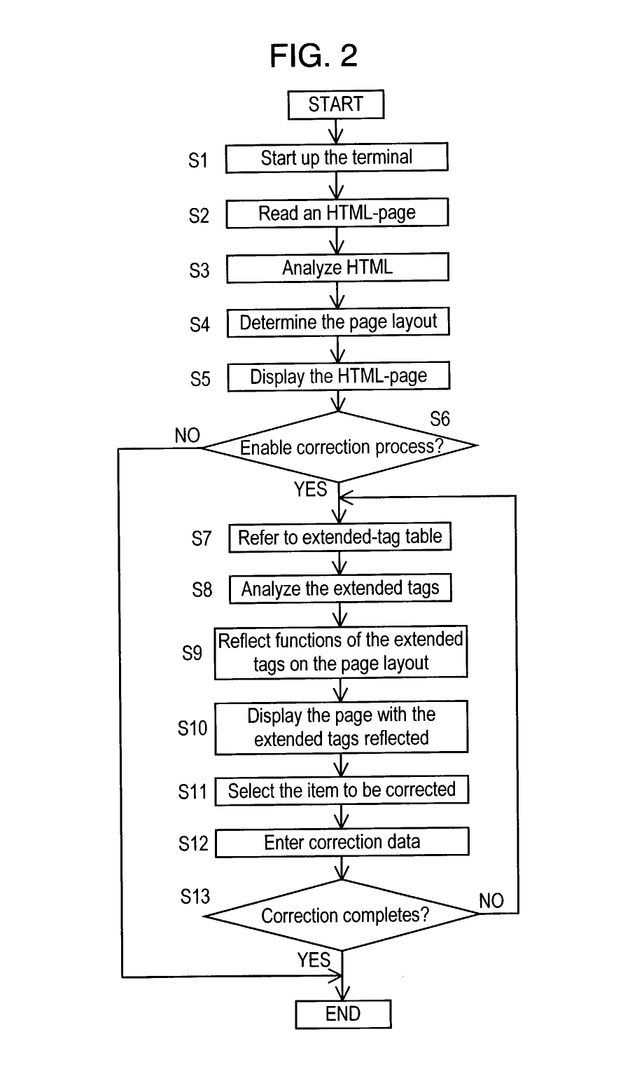

FIG. 2 is a flow chart illustrating steps of updating Web pages in apparatus 20 having the structure shown in FIG. 1. With the steps, the user can easily update the HTML-page, confirming the contents to be corrected on the screen.

Here will be described the process step by step. In S1 of FIG. 2, apparatus 20 is started up so that apparatus 20 have access to a Web page that needs for correction. In S2, communicator 6 reads an HTML-file to be corrected in the Web page. In S3, analyzer 8 analyzes the HTML-file with reference to HTML specifications. In S4, according to the result obtained in S3, page layout section 9 determines each position of display elements in the Web page to display them in place in display 2 of apparatus 20. In S5, page display section 10 displays each element at proper position on display 2 according to the layout given by S4.

Correction will be given the steps from S6 through S13. Showing the page to be corrected (hereinafter referred to as the pre-correction page) on display 2, the user determines whether extended tag-analysis will be enabled or not—enabling the extended tag-analysis starts the correction process in S6. To identity items to be corrected and attributes of the items, CPU 1 acquires the extended tags from extended-tag table 12 in S7. CPU 1 requests extended-tag analyzer 13 to find extended tags matching with ones acquired in S7, in the pre-correction page and extracts the items sandwiched between the extended tags in S8. CPU 1 determines the location of the display elements with the extended tags extracted in S8 to be highlighted. In S10, the highlights are given as, for example, crosshatch, inverse video, and colored text to the items having the extended tags, which have been identified in S7 through S9.

In addition to the HTML-page commonly provided by a Web browser, as described above, the HTML-page on display 2 has the highlights, at which the items have been specified with the extended tags in the HTML-page. Having the highlights can explicitly tell the user which item should be corrected in the page.

In S11 of FIG. 2, the user moves the cursor to the item to be corrected, i.e., to the highlighted item, browsing the page on display 2. When the user selects an item, which is usually initiated by depressing a button for starting correction, CPU 1 requests display 2 to show the entry window corresponding to the extended tags indicating the contents (i.e., attribute) of the selected item. In this way, the user rewrites the item in S12. If the user has the need for more correction in the same page, the steps of S7 through S12 are repeated as in S13. The storage medium and the input device employed in the embodiment may be conventionally known ones.

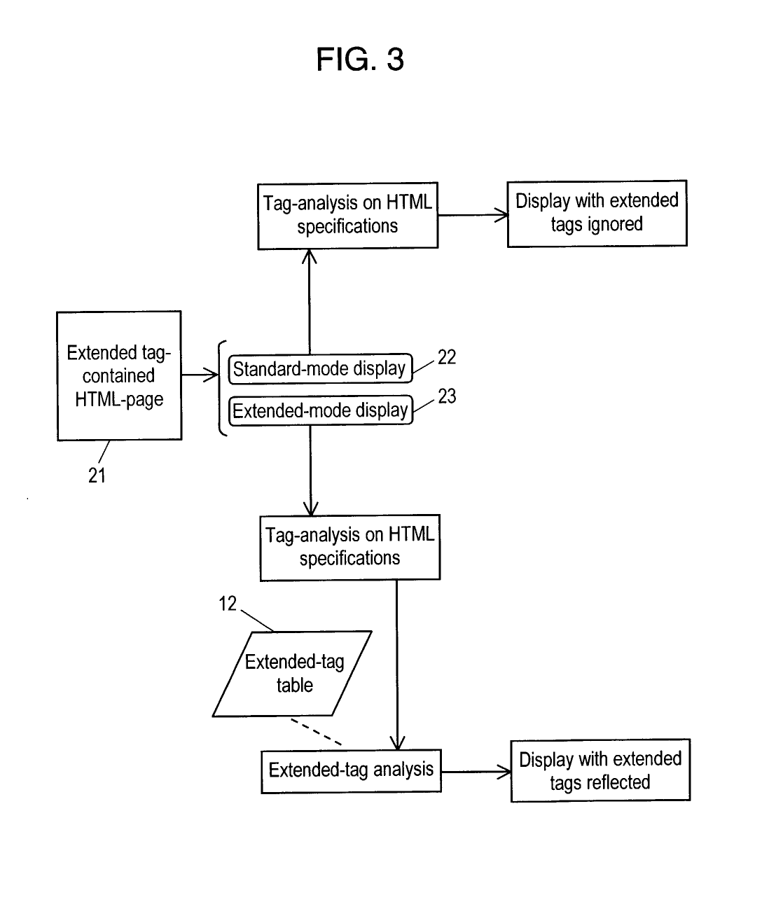

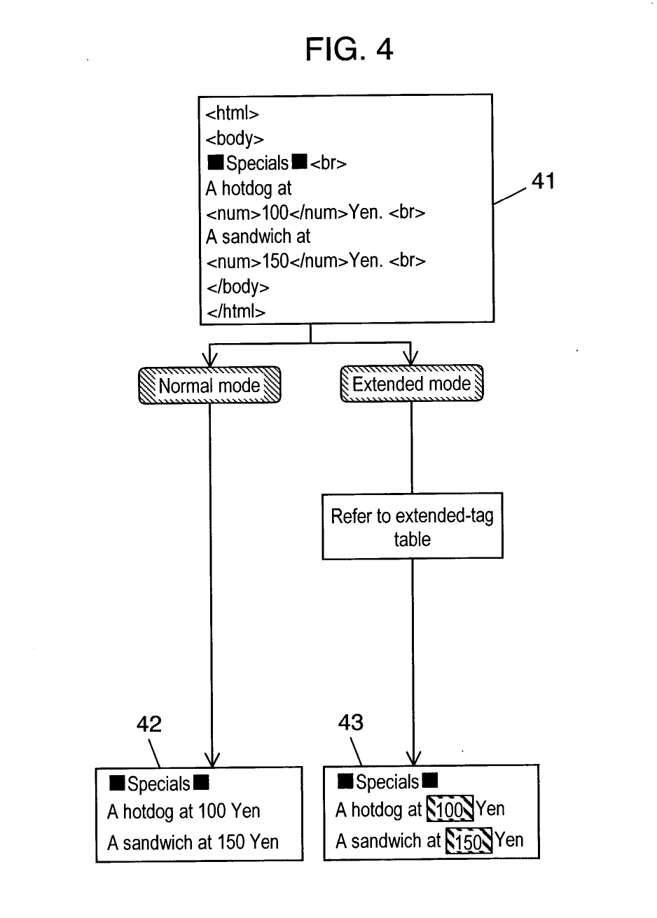

FIGS. 3 and 4 illustrate two display-modes of apparatus 20: one is the standard mode that is the same as a Web browser offers; the other is the extended mode in which the functions of the extended tags are reflected. Which mode will be shown on display 2 depends on predetermined setting in apparatus 20. An HTML-page is shown on display 2, switched between the standard mode and the extended mode according to the setting. FIG. 3 illustrates how HTML-page 21 is processed according to the two modes of apparatus 20 described above.

When reading HTML-page 21 having the extended tags placed before and after the item to which frequent correction is expected, apparatus 20 selects standard mode 22 or extended mode 23 according to the setting pre-stored in storage section 5. In extended mode 23, the functions of the extended tags are reflected.

In the case that the standard mode is selected, apparatus 20 analyzes the HTML-page faithfully on HTML specifications: the extended tags in the page are ignored. Therefore, the HTML-page shown on display 2 is the same as that provided by a Web browser.

On the other hand, in the case that the extended mode is selected, apparatus 20 searches the page for the extended tags that match with those stored in extended-tag table 12 in addition to the analysis on HTML specifications. As a result, the HTML-page shown on display 2 has the highlights, at which the items have been specified with the extended tags.

Now will be explained in detail how the extended tags work in the display process with reference to FIG. 4. Suppose that HTML-page 41 in FIG. 4 needs for correction. The user has described the extended tags such that a pair of tags sandwich an item to which frequent correction is expected. Suppose that the extended tags used here are <num> as a start tag, and </num> as an end tag, indicating that the attribute of the item is numeral. In FIG. 4, numerals “100” and “150” are each sandwiched between <num> and </num>.

When apparatus 20 selects the standard mode, the HTML-tag analyzer of apparatus 20 ignores the <num> tags due to its in compliance with HTML specifications—screen 42 in FIG. 4 appears on display 2, which is similar to that by a Web browser. On the other hand, when selecting the extended mode, apparatus 20 searches the page for the extended tags that match with those stored in extended-tag table 12. In page 41 including the <num> tags, apparatus 20 locates the items—in the example, the numerals “100” and “150”—sandwiched between tags of <num> and </num>, then provides the items with highlights. In this way, screen 43 appears on display 2. The extended mode offers the display having the advantage of the extended tags, providing the user with easy and quick correction.

When reading an HTML-page including the extended tags, apparatus 20 changes the display mode from the standard mode to the extended mode, allowing the user to easily correct or confirm the item that needs for updating.

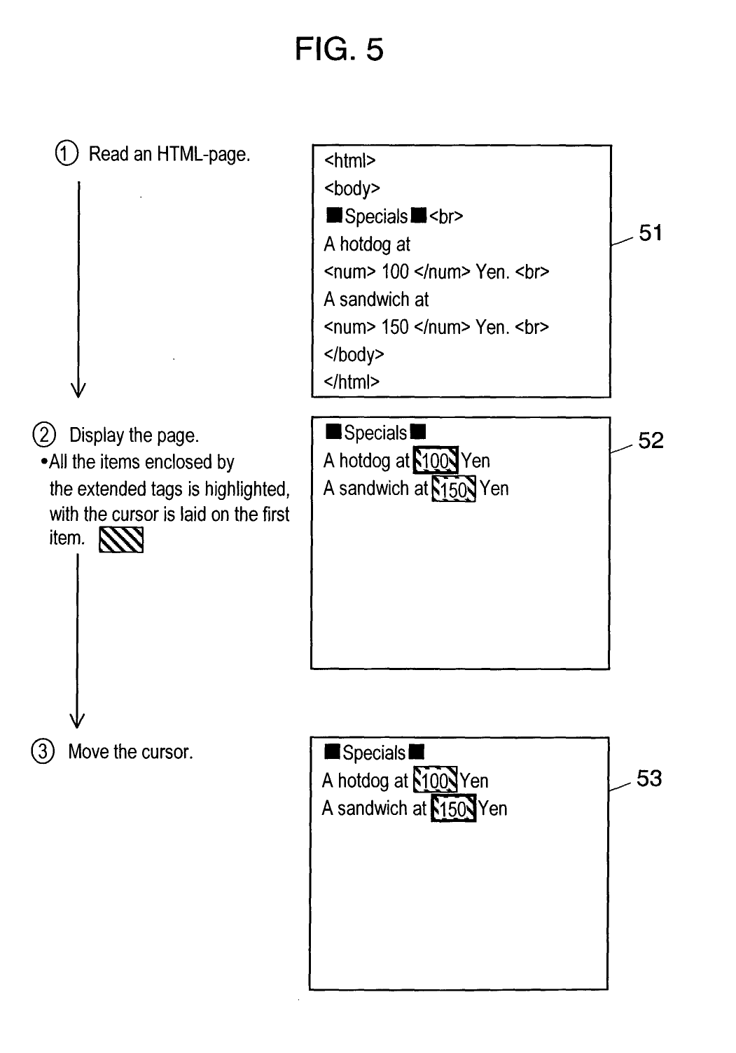

Now will be described how to select an item among two or more items to be corrected in a page, with reference to FIG. 5.

Unlike a PC, a mobile telephone having access to the Internet—such as apparatus 20 of the embodiment—cannot select a desired position on the display by pointing at it with the mouse. In such a mobile terminal, the up-, down-, right-, and left-arrow keys are usually used to move a cursor, instead of the pointing device. In this case, it is necessary to predetermine the move of the cursor in the page so that the cursor quickly moves to a next position each time one of the arrow keys is pressed. In this way, the user can move the cursor, with the arrow keys, between data-entry items or sections having inter-links with other sections in the HTML-page.

In the standard mode of apparatus 20, the cursor moves in an HTML-page, as is the case with a common Web browser. On the other hand, in extended mode 51 of FIG. 5, apparatus 20 ignores the positions that the cursor would stop by in the standard mode: the cursor straightforwardly moves to the item sandwiched between the extended tags—the user-defined items that need for correction as shown in screen 52 and 53 of FIG. 5. The quick move of the cursor explicitly indicates correctable items. This provides the user with at-a-glance recognition, encouraging efficient updating routine.

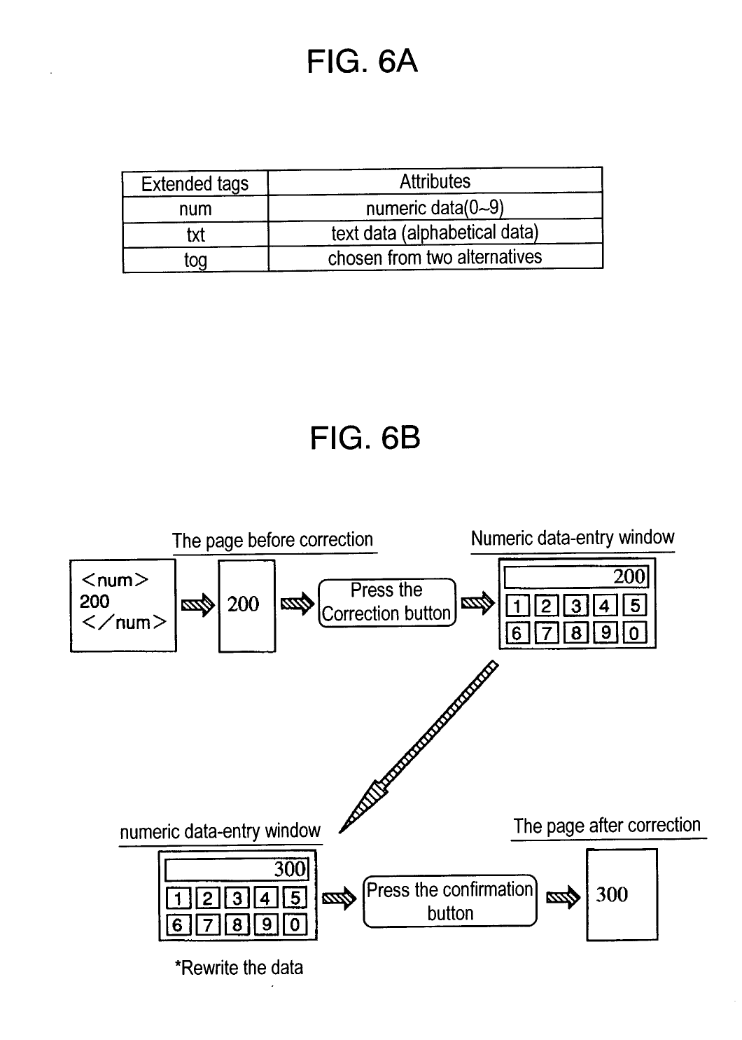

The extended tags designate not only correctable items but also attributes of the items, which simplifies the updating process. FIG. 6A shows the correspondence of the extended tags and attributes and FIG. 6B shows the simplified process in updating.

The user uses an extended tag so as to correspond to the attribute of the item. When reading an HTML-page including the extended tags, apparatus 20 gives highlights to the item sandwiched between the extended tags and, at the same time, recognizes the attribute of the item according to the tags. Confirming the highlighted items, the user moves the cursor to desired item. At the time, apparatus 20 checks the extended tag for attribute and accordingly offers the proper entry window. This will be a great help to the user in data entry.

FIG. 6A shows the correspondence between the extended tags and attributes. The <num> tag, as shown in the table, represents an attribute of numeral. Now referring to FIG. 6B, suppose that apparatus 20 displays an HTML-page including an item—the numeral “200” in FIG. 6B—enclosed by tags of <num> and </num>, and the focus lies on the numeral “200”. When the user presses the button initiating correction, apparatus 20 automatically changes the display into numeric data-entry window having a ten-digit keypad.

Similarly in FIG. 6A, the <txt> tag represents an attribute of text; the <tog> tag is for the item to be chosen from two alternatives. That is, the user can designate the <txt> tag for text data-entry, and the <tog> tag for the item having two alternatives. Designating these tags in the HTML-page allows apparatus 20 to automatically show the data-entry window corresponding to the attribute of each item. This eliminates the user having to manually change the mode for data entry. Even in the case that correction-required items are scattered here and there in a page, apparatus 20 can exactly locate the item to be corrected and prepare the proper entry window, thereby accelerating the updating process.

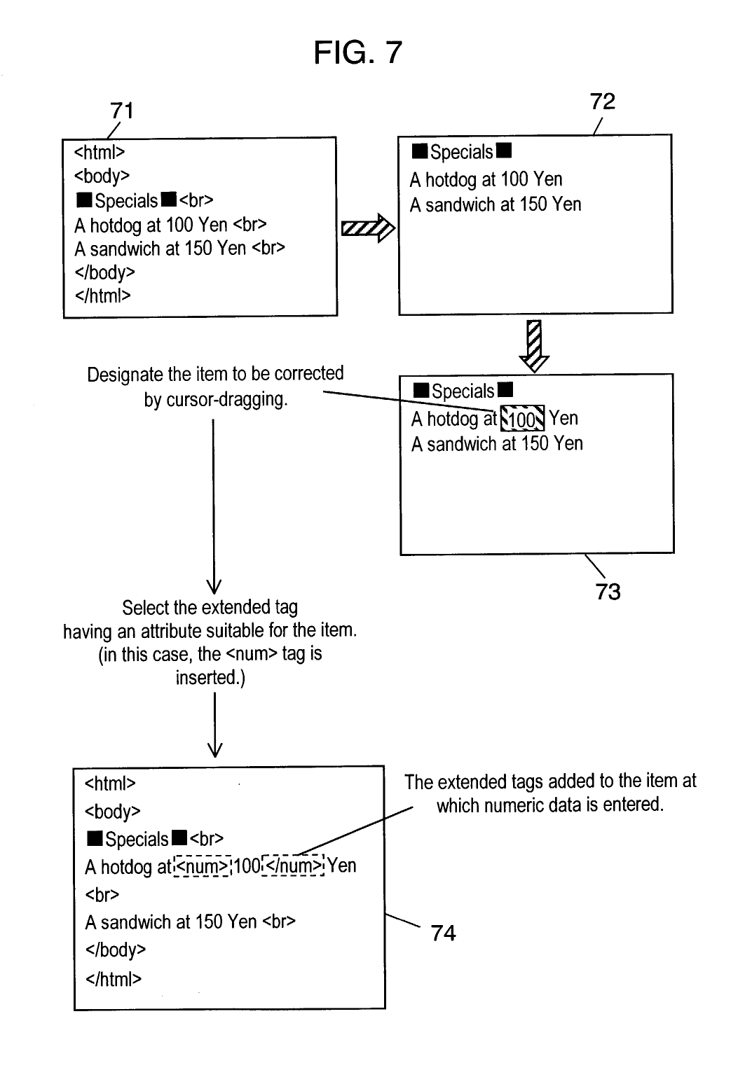

Here will be described how to insert the extended tags, which have been stored in apparatus 20, into an HTML-page read from a Web site via the Internet, with reference to FIG. 7.

HTML-page 71 having no extended tags will be seen as screen 72, through a Web browser. If the numeric data of “100” in screen 72 is likely to have frequent correction, the user can designate the data as correction-required item by inserting the extended tags as follows:

i) highlighting the numeric data—in this case, the numeric value “100” on screen 73—for example by cursor-dragging; then

ii) selecting the extended tag matching with the attribute, i.e., the type of the data from the extended-tag table of apparatus 20—here in the example, the user is supposed to select the <num> tag.

In response to the selection, apparatus 20 squeezes the extended tags into HTML-page 71 in such a way that the correction-required data is sandwiched between <num> and </num>. HTML-page 74 in of FIG. 7 is thus generated. All that the user has to do for inserting the extended tags is: highlighting the data in the page on the display, and then selecting an extended tag suitable for the attribute of the data.

As described above, referring to the HTML-page, the user can easily determine the position at which the extended tag is inserted. Although highlighting specifies the data in the embodiment, it is not limited thereto as long as the intended position can be clearly distinguished from the rest of the page.

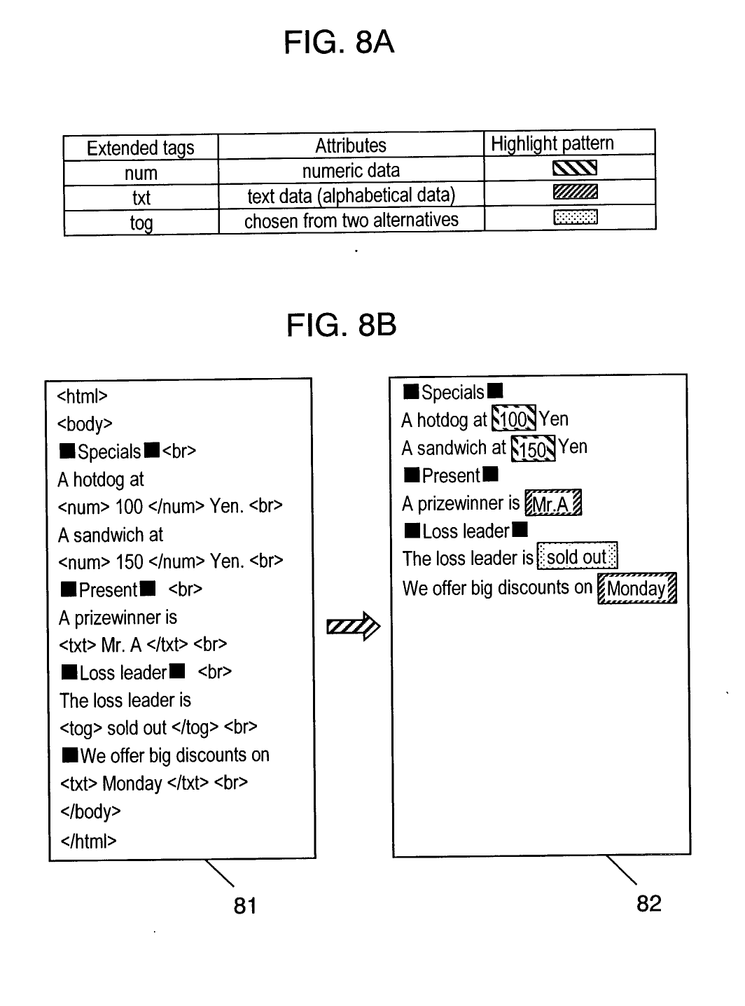

Extended-tag table 12 in apparatus 20 has a plurality of extended tags, each of which represents different attribute. If different extended tags are inserted in a page, as shown in HTML-page 81 of FIG. 8B, it would be difficult for the user to distinguish the type of each tag in the HTML-page. Employing highlights distinguished by using different colors, or using different patterns as shown on screen 82 in FIG. 8A will be great help for easy-to-see display. With such improvements, the user can recognize the location and attribute of each correction-required items in the page. This will shorten the time spent for the updating process.

Second Preferred Embodiment

Having the structure similar to that of the first preferred embodiment, apparatus 20 of the embodiment reads an HTML-page including the extended tags prior to the updating process. However, it differs from the procedure introduced in the first preferred embodiment in that apparatus 20 offers the user a correction-dedicated page. The window has correction-required items extracted from the HTML-page with the extended tags. That is, data rewritten on the correction-dedicated page by the user is directly reflected on the HTML-page on the Internet.

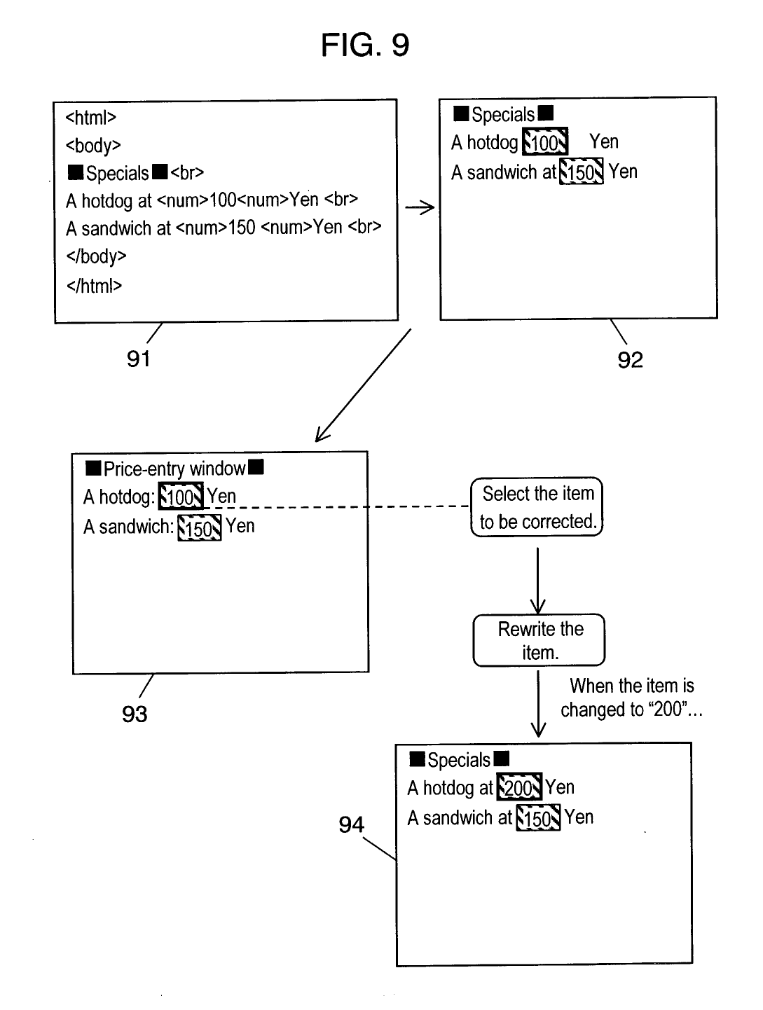

The method will be explained hereinafter with reference to FIG. 9. HTML-page 91 having extended tags is shown as screen 92 in the extended mode. Apparatus 20 generates correction-dedicated window 93 on which correction-required items are extracted. Apparatus 20 offers the user, as shown in FIG. 9, numeric-entry window 93 having the numeric values “100” and “150” that are extracted from screen 92. With no need for browsing HTML-page 92, the user can update the values on window 93. The contents rewritten on window 93 are directly reflected on the HTML-page that will be put up on the user's Web page. On completion of the correction, screen 94 appears on display 2 of apparatus 20.

According to the embodiment, as described above, apparatus 20 offers the user a correction-dedicated page, which is separately generated from an HTML-page. The correction given on the window is directly reflected on the HTML-page automatically.

The first preferred embodiment introduces the method that makes it easy to change the correctable in which the user selects a correction-required item by moving the cursor between the highlighted items in the HTML-page shown on display 2. In the method, the operator is practically limited to a person who is familiar with the structure of the Web page, namely, the author of the Web page. On the other hand, for a user having some basic hands-on experience, the method of the second embodiment having correction-dedicated page may be easy to use rather than that of the first preferred embodiment: the correction-dedicated page having guidance for data-entry provides user-friendly circumstance, thereby dividing up the updating routine with coworkers, not limited to the author of the Web page.

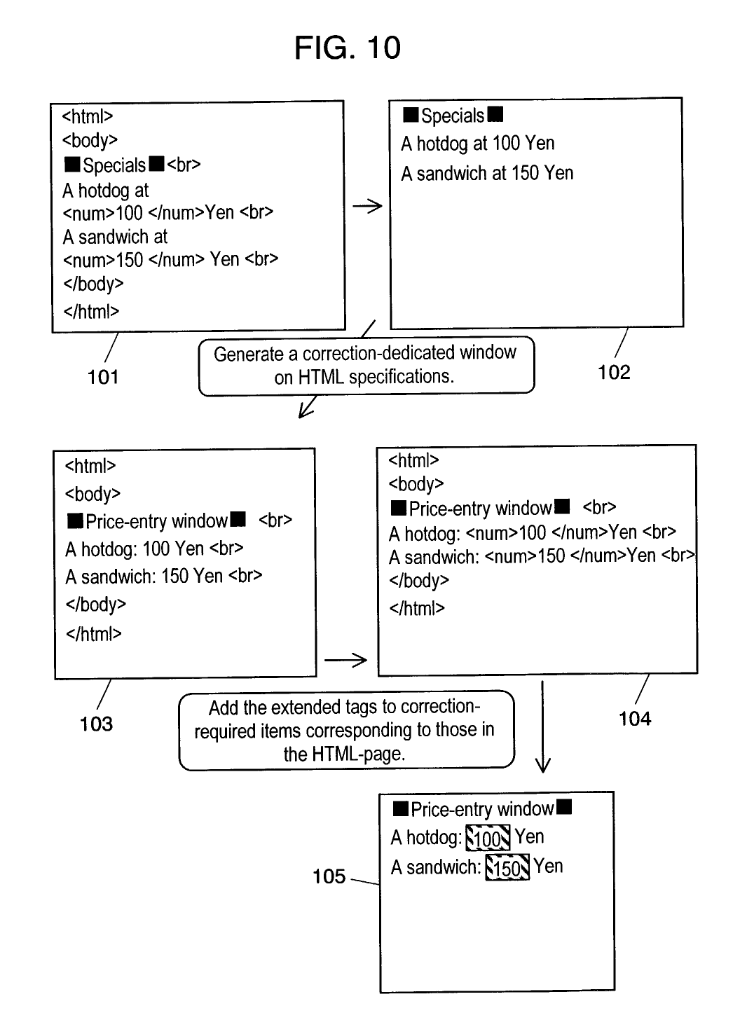

FIG. 10 illustrates how to create the correction-dedicated page mentioned above. Apparatus 20 can show the dedicated page on display 2 because the page is also written by HTML. The user can rewrite the values in the page while browsing it, just as in the case of visiting a Web page. Apparatus 20 generates correction-dedicated page 103 using HTML, according to HTML-page 101 that corresponds to screen 102. This process is the same as that performed in generally used to update HTML files. Apparatus 20 searches the items having extended tags in HTML-page 101 and adds the tags to the corresponding items in page 103 to change it into page 104. Having a correspondence between the two pages allows the correction given in the correction-dedicated page to be directly reflected on the HTML-page, which will be up on the Internet.

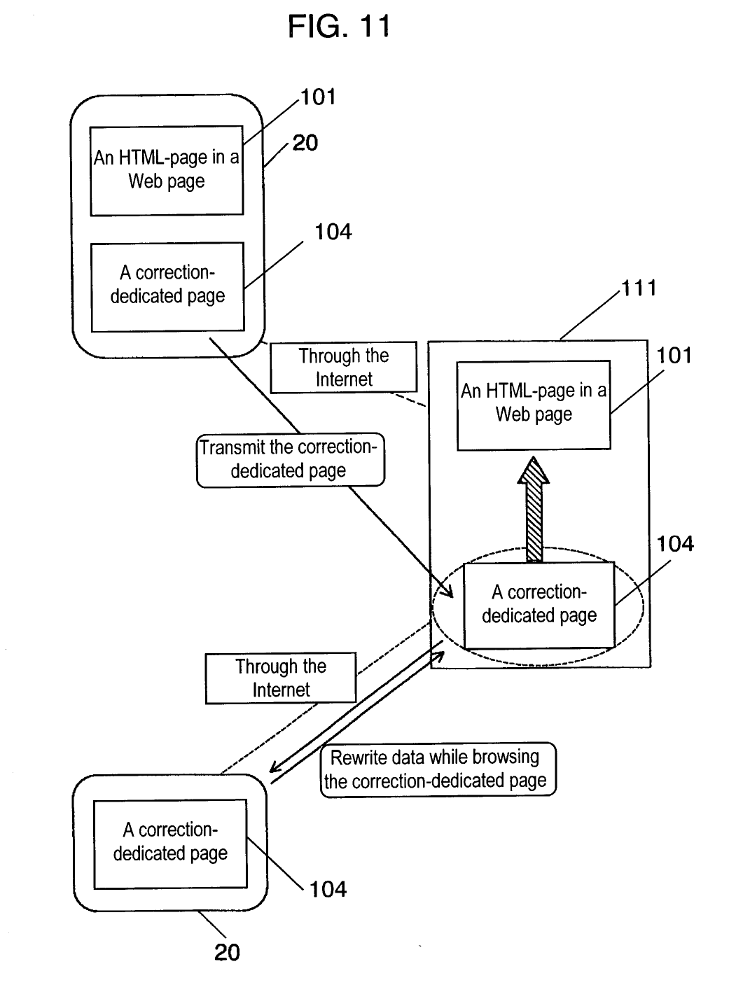

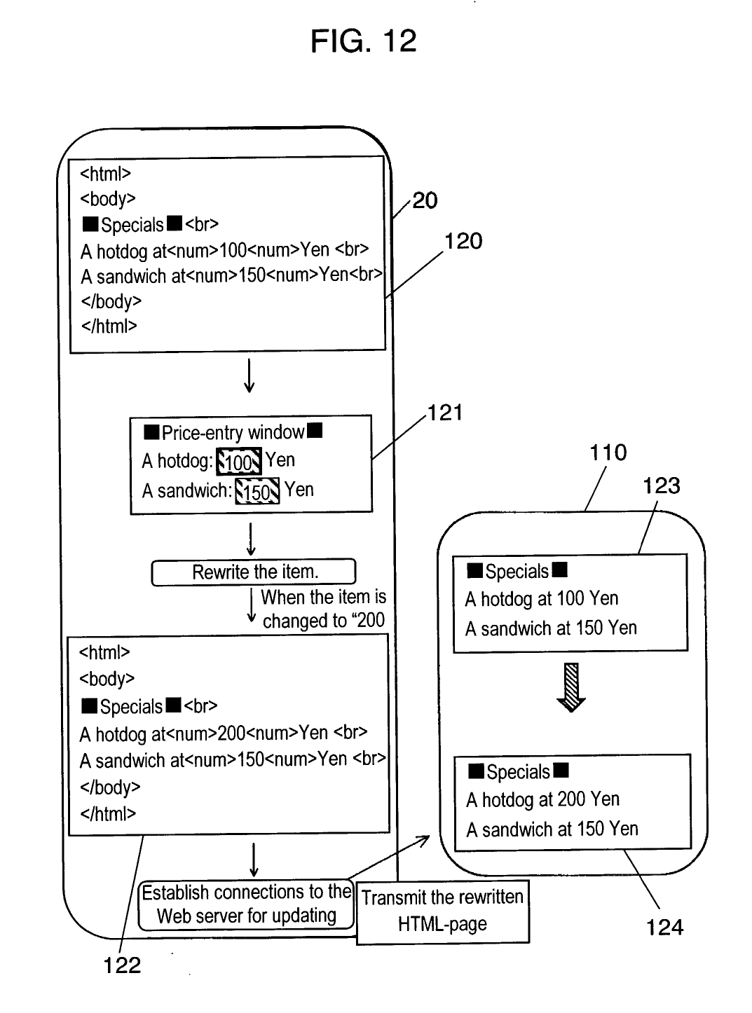

After the correction in apparatus 20, the updated pages are automatically transmitted to Web server 110 on the Internet. FIGS. 11 and 12 illustrate the process above. Through the process, Web server 110 acquires correction-dedicated page 104 containing correction-required items with extended tags. In this way, the correction given to page 104 is conveniently reflected on the associated page on the Internet.

FIG. 11 shows the case in which the correction is given to HTML-page 101 read by apparatus 20. The user can store items to be corrected in apparatus 20 in advance of correction. Each time the items are corrected by the user, apparatus 20 automatically transmits the corrected file to Web server 110. Unlike the conventional updating process in which correction given by the author of a Web page has been transmitted as a batch process, the method of the embodiment offers the user real-time correction—the user can correct the value in the correction-dedicated page according to the guidance on the display at any time correction is required. Receiving the entry from the user, apparatus 20 automatically sends them to the Web server.

FIG. 12 illustrates the process described above showing the correspondence between the HTML-page and the screen appears on display 2 of apparatus 20. The user moves the cursor to the numeral “100”—which is highlighted on correction-dedicated page 121 corresponding to HTML-page 120 having extended tags—and replaces it with “200”. In response to the entry, apparatus 20 transmits updated HTML-page 122 to Web server 110, then changes the correction-dedicated page on the Web server 110 according to HTML-page 122. As a result, screen 123 is replaced with screen 124. All the user has to do for updating his/her Web page is to enter required information in the correction-dedicated page at-all-times available on the server, with reference to the page having the items to be corrected through the Internet. In addition, each time a correction is given to the correction-dedicated page, apparatus 20 automatically establishes connections to server 110 to transmit the corrected page after comparison with the HTML-page being publicized on the Internet. This function encourages a simple and quick updating routine.

The Web page-updating method described in aforementioned embodiments can be performed through a computer program product, which implements the Web page-updating routine, installed in a commonly used multipurpose mobile terminal. Besides, such a program product can be stored in a commonly used multipurpose recording medium.

What is claimed is:

1. A Web page-updating apparatus for correcting data in a Web page on a Web server on the Internet, the apparatus comprising:
a) a communicator capable of transmitting and receiving an HTML-written file (hereinafter, HTML-file) of a Web page;
b) a display for displaying the HTML-file as an HTML-written source (hereinafter, HTML-page); and
c) a data-entry section that allows a user to input information,
wherein the display displays the HTML-file received from the communicator as the HTML-page in which an item enclosed by a pair of extended tags are explicitly indicated, and information including corrected data, which is given by the user via the data-entry section to the item enclosed by a pair of the extended tags, is transmitted through the communicator to the server.

2. A Web page-updating apparatus for correcting data in a Web page on a Web server on the Internet, the apparatus comprising:
a) a display for displaying a Web page; and
b) a storage section including:
b-1) extended-tag table for storing at least a pair of extended tags which designate an attribute of a correction-required item in an HTML-file of the Web page;
b-2) an extended-tag analyzer for analyzing each of the pair of extended tags in the HTML-file so as to find items enclosed by each of the pair of extended tags;
b-3) a correction data-entry section for preparing a data-entry window, which is suitable for the attribute indicated by each of the pair of extended tags, on the display; and
b-4) a page rewriter for updating correction-required HTML-file on the Web server in response to correction given to the items designated by each of the pair of extended tags.

3. The Web page-updating apparatus as defined in claim 1, wherein the apparatus has two display-modes: one is a standard mode that shows an extended tag-contained HTML-page on the display section, with a function of the pair of extended tags ignored; and the other one is an extended mode that explicitly shows items marked with the pair of extended tags, with the function of the extended tags reflected on the display.

4. The Web page-updating apparatus as defined in claim 1, wherein in case that the apparatus receives an HTML-file with plurality of items enclosed by pair of extended tags, the apparatus provides the items enclosed by the pair of extended tags with highlight in an extended tag-contained HTML-page shown on the display, and the user selects an item to be corrected by moving a cursor among the highlighted items.

5. The Web page-updating apparatus as defined in claim 1, wherein the apparatus allows the user i) to select the pair of extended tags that represents an attribute suitable for an item to be corrected and ii) to add the pair of tags to the item in the HTML-page on the display.

6. The Web page-updating apparatus as defined in claim 1, wherein the apparatus shows the HTML-page on the display section, providing the items enclosed by the pair of extended tags with color-coded display according to the attribute assigned to each of the pair of extended tags.

7. The Web page-updating apparatus as defined in claim 1, wherein the apparatus generates a correction-dedicated page having a correctable item with an attribute that are extracted from the corresponding HTML-page containing the pair of extended tags, then displays the correction-dedicated page on the display section.

8. The Web page-updating apparatus as defined in claim 7, wherein each time the item shown on the correction-dedicated page is corrected by the user, the apparatus automatically changes contents of the HTML-file corresponding to the item on the correction-dedicate page.

9. The Web page-updating apparatus as defined in claim 7, wherein the apparatus stores the correction-dedicated page in the Web server on the Internet so that the user can browse the page as required.

10. The Web page-updating apparatus as defined in claim 1, wherein each time a correction is given to an item in the HTML-file loaded into the apparatus, the apparatus automatically establishes connections to the Web server to transmit the correction thereto for updating the HTML-file on the Web server.

11. A Web page-updating method comprising the steps of:
a) receiving an HTML-file from a Web server on the Internet;
b) displaying the HTML-file as an HTML-page, in which an item enclosed by a pair of extended tags are explicitly indicated, on a display of an apparatus;
c) transmitting correction data to the Web server in response to data-entry by a user; and
d) rewriting data in the HTML-file on the Web server according to the received correction data.

12. The Web page-updating method as defined in claim 11, the method further includes a step of switching between two display-modes: one is a standard mode that shows an extended tag-contained HTML-page on the display section, with a function of the pair of extended tags ignored; and the other one is an extended mode that explicitly shows items marked with the pair of extended tags, with the function of the pair of extended tags reflected on the display.

13. The Web page-updating method as defined in claim 11, the method further includes two steps in case that the apparatus receives an HTML-file with plurality of items enclosed by pair of extended tags: one is providing items enclosed by the pair of extended tags with highlight in an extended tag-contained HTML-page; the other is allowing the user to select an item to be corrected by means of cursor move among the highlighted items in the HTML-page.

14. The Web page-updating method as defined in claim 11, the method further includes a step of inserting the pair of extended tags in the HTML-page shown on the display.

15. The Web page-updating method as defined in claim 14, wherein the user selects the pair of extended tag that represents an attribute suitable for an item to be corrected.

16. The Web page-updating method as defined in claim 14, wherein the step of inserting the pair of extended tags allows the user to designate a correction-required item in the HTML-page.

17. The Web page-updating method as defined in claim 11, wherein the step of b) shows the HTML-page on the display section, providing the items enclosed by the pair of extended tags with color-coded display according to the attribute assigned to each extended tag.

18. The Web page-updating method as defined in claim 11, the method further includes a step of generating a correction-dedicated page showing a correctable item with an attribute that are extracted from the corresponding HTML-page containing the pair of extended tags.

19. The Web page-updating method as defined in claim 18, the method further includes a step of automatically changing contents of the HTML-file in correspondence with an item in the correction-dedicate page, each time the item shown on the correction-dedicated page is corrected by the user.

20. The Web page-updating method as defined in claim 18, the method further includes a step of storing the correction-dedicated page in the Web server.

21. The Web page-updating method as defined in claim 11, the method further includes a step of having automatic connections to the Web server to transmit correction thereto for updating the HTML-file on the Web server, each time correction is given to an item in the loaded HTML-file.

22. A Web page-updating program product stored in a computer-readable medium, the program product comprising the instructions of:
a) receiving an HTML-file from a Web server on the Internet;
b) displaying the HTML-file as an HTML-page, in which an item enclosed by a pair of extended tags is explicitly indicated, on a display of an apparatus;
c) transmitting correction data to the Web server in response to data-entry by a user; and
d) rewriting data in the HTML-file on the Web server according to the received correction data.

23. A Web page-updating program product comprising program code of:
a) receiving an HTML-file from a Web server on the Internet;
b) displaying the HTML-file as an HTML-page, in which an item enclosed by a pair of extended tags is explicitly indicated, on a display of an apparatus;
c) transmitting correction data to the Web server in response to data-entry by a user; and
d) rewriting data in the HTML-file on the Web server according to the received correction data.
